(19) United States
(12) Patent Application Publication
(10) Pub. No.: US 2016/0208736 A1
(43) Pub. Date: Jul. 21, 2016

(54) Solar-Powered Hot Air Engine

(71) Applicant: Clayton Yaun, Pueblo West, CO (US)

(72) Inventor: Clayton Yaun, Pueblo West, CO (US)

(21) Appl. No.: 14/995,030

(22) Filed: Jan. 13, 2016

Related U.S. Application Data
(60) Provisional application No. 62/105,580, filed on Jan. 20, 2015.

(51) Int. Cl. F02G 1/043; F03G 6/06; F02G 1/057

(52) U.S. Cl. CPC F02G 1/043; F02G 1/057; F03G 6/068

(57) ABSTRACT

A solar-powered hot air engine has a cylinder with hot and cold ends, and a solar collector directing radiation through a window into the hot end of the cylinder. A thin layer of regenerator material having low thermal conductivity is placed on the face of the displacer piston at the hot end of the cylinder, and a layer of material with high absorptivity and low emissivity covers the regenerator material and the interior surface of the cylinder to maximize absorption of the solar energy within the hot end of the cylinder.

### RELATED APPLICATION

The present application is based on and claims priority to the Applicant's U.S. Provisional Patent Application 62/105,580, entitled “Solar-Powered Hot Air Engine,” filed on Jan. 20, 2015.

### BACKGROUND OF THE INVENTION

1. Field of the Invention

The present invention relates generally to the field of hot air engines. More specifically, the present invention discloses a solar-powered hot air engine.

2. Background of the Invention

A variety of hot air engines, such as Stirling engines, have been in existence for centuries. A general summary is provided in the Wikipedia article on Stirling engines, which discusses the various configurations of a Stirling engine and is hereby incorporated by reference. The prior art in this field also includes a variety of solar-powered hot air engines, as taught for example, by U.S. Pat. No. 6,996,983 (Cameron), U.S. Pat. No. 5,404,723 (Parker et al.) and U.S. Pat. No. 4,642,988 (Benson).

For example, the Cameron patent discloses a rotary Stirling engine having a glass window for transmitting solar radiation into the heat chamber. Cameron also discloses a blackened wall within the heat chamber for absorbing solar radiation.

However, it appears that nothing in the prior art teaches or suggests a solar-powered hot air engine having the specific physical configuration of the present invention. In particular, the present invention employs a thin disk of regenerator material having low thermal conductivity on the face of the displacer piston at the hot end of the cylinder, and a layer of material with high absorptivity and low emissivity covers the regenerator material and the interior surface of the cylinder. This configuration has the advantages of being directly applicable to conventional hot air engines that use pistons, such as the beta-type Stirling engine shown in FIG. 1. In addition, the present invention has the advantage of transmitting and absorbing solar radiation directly in the working fluid in the hot end of the cylinder where its thermal energy can be most efficiently put to use.

### SUMMARY OF THE INVENTION

This invention provides a hot air engine, such as a Stirling engine, having a cylinder with hot and cold ends, and a solar collector directing radiation through a window into the hot end of the cylinder. A thin layer of regenerator material having low thermal conductivity is placed on the face of the displacer piston at the hot end of the cylinder, and a layer of material with high absorptivity and low emissivity covers the regenerator material and the interior surface of the cylinder to maximize absorption of the solar energy within the hot end of the cylinder.

These and other advantages, features, and objects of the present invention will be more readily understood in view of the following detailed description and the drawings.

### BRIEF DESCRIPTION OF THE DRAWINGS

The present invention can be more readily understood in conjunction with the accompanying drawings, in which:

FIG. 1 is a cross-sectional diagram of a beta-type Stirling engine embodying the present invention with a solar collector.

FIG. 2 is a detail cross-sectional diagram of the hot end of the cylinder and displacer piston of the Stirling engine.

### DETAILED DESCRIPTION OF THE INVENTION

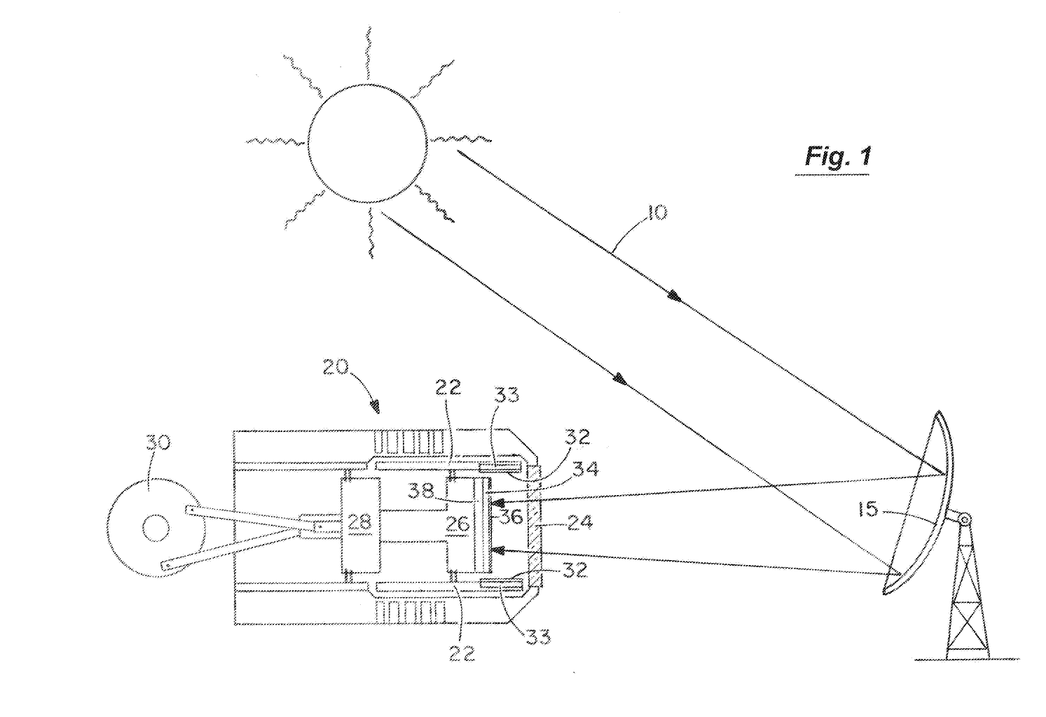

Turning to FIG. 1, a cross-sectional diagram is provided showing a Stirling engine 20 embodying the present invention with a solar collector 15. The Stirling engine 20 in this drawing is configured as a beta Stirling engine with a cylinder 22 having a hot end and a cold end. A displacer piston 26 at the hot end and a power piston 28 at the cold end move the working fluid (e.g., air) between the ends of the cylinder 22. The pistons 26, 28 are connected by conventional linkages to a flywheel 30. It should be understood that other configurations of the Stirling engine could be readily substituted, or that other types of hot air engines could be employed.

A solar collector 15 (e.g., a parabolic reflector) directs solar radiation 10 through a window 24 into the hot end of the cylinder 22. The window 24 can be made of glass or a suitable transparent ceramic material. Preferably, the window 24 is located at the head of the hot end of the cylinder 22, so that solar radiation 10 gathered by the solar collector 15 passes through the window 24 into the hot end of the cylinder 22 and toward the face of the displacer piston 26 as illustrated in FIG. 1.

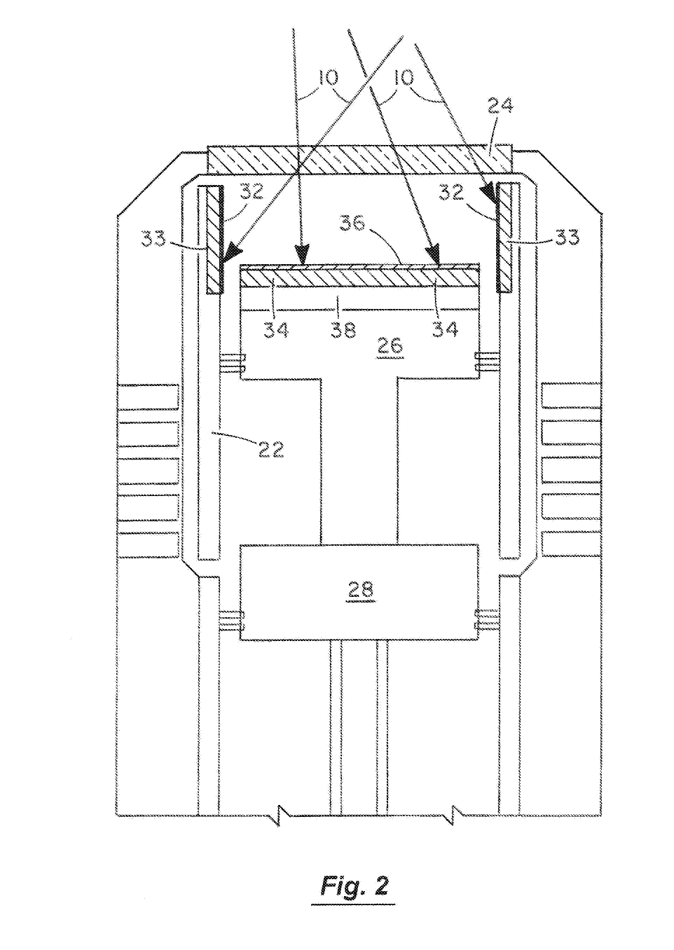

FIG. 2 is a detail cross-sectional diagram of the hot end of the cylinder 22 and displacer piston 26 of the Stirling engine 20 corresponding to FIG. 1. A thin layer or disk of regenerator material 34 is secured to the face of the displacer piston 26 to provide heat transfer between the hot and cold gas flows in the hot chamber over the course of the engine cycle. Examples of possible regenerator materials include a carbon foam material that is commercially available from a variety of sources (e.g., C-Foam) and ceramics.

As shown in FIG. 2, an absorptive coating 36 (i.e., a thin layer of material having high absorptivity and low emissivity) is applied to the surface of the regenerator material 34 to enhance absorption of solar radiation 10 entering the hot chamber. Similarly, the interior surface of hot end of the cylinder 22 can also be equipped with an absorptive layer 32, as shown in FIG. 2. These absorptive coatings 32, 36 serve to concentrate incoming radiant heat on the very top layers of molecules of the regenerator material 34 and the interior surface of the cylinder 22, resulting in higher surface temperatures. As a result, more thermal energy is transferred faster to the working fluid in the hot chamber and engine efficiency is increased. The working gas molecules are directly heated or energized when they collide with the superheated thin absorptive layer 36.

Any of a wide variety of materials can be employed as the absorptive coating, including carbon black, nickel III oxide (Ni₂O₃), ceramics and ceramic/metal composite materials (i.e., cermet materials). An extensive list of potentially-suitable materials is provided on page 12 of C. E. Kennedy, “Review of Mid- to High-Temperature Solar Selective Absorber Materials” (National Renewable Energy Laboratory, July 2002, NREL/TP-520-31267), which is hereby incorporated by reference. Optionally, a layer of regenerator material 33 can be placed between the absorptive layer 32 and the wall of the cylinder 22, as shown in FIG. 2.

The effectiveness of the absorptive layers 32, 36 can be enhanced by increasing the exposed surface area of these layers. For example, this can be done by creating a three-dimensional texture to the surfaces. The increased surface area provides greater absorption of incoming solar radiation by the absorptive layers 32, 36, and also increases heat transfer to the working gas in the hot chamber of the cylinder 22.

Optionally, the present invention can also include an insulating layer 38 between the regenerator material 34 and the face of the piston 26 to decrease unwanted heat transfer into the piston 26. For example, the insulating layer 38 could be multi-layer insulation or suitable refractory material.

The above disclosure sets forth a number of embodiments of the present invention described in detail with respect to the accompanying drawings. Those skilled in this art will appreciate that various changes, modifications, other structural arrangements, and other embodiments could be practiced under the teachings of the present invention without departing from the scope of this invention as set forth in the following claims.

I claim:

1. A solar-powered hot air engine comprising:
a cylinder having an interior with hot and cold ends;
a displacer piston within the hot end of the cylinder;
a window in the hot end of the cylinder;
a solar collector directing radiation through the window into the hot end of the cylinder;
a layer of regenerator material having low thermal conductivity on the face of the displacer piston; and
a thin layer of absorptive material with high absorptivity and low emissivity on the regenerator material.

2. The solar-powered hot air engine of claim 1 wherein the regenerator material comprises carbon foam.

3. The solar-powered hot air engine of claim 1 wherein the regenerator material comprises a ceramic material.

4. The solar-powered hot air engine of claim 1 wherein the absorptive material comprises carbon black.

5. The solar-powered hot air engine of claim 1 wherein the absorptive material comprises nickel III oxide (Ni₂O₃).

6. The solar-powered hot air engine of claim 1 wherein the absorptive material comprises a ceramic material.

7. The solar-powered hot air engine of claim 1 wherein the absorptive material comprises a ceramic/metal composite material.

8. The solar-powered hot air engine of claim 1 further comprising a thin layer of absorptive material with high absorptivity and low emissivity on the interior of the hot end of the cylinder.

9. The solar-powered hot air engine of claim 8 further comprising a layer of regenerator material having low thermal conductivity beneath the layer of absorptive material on the interior of the hot end of the cylinder.

10. A solar-powered hot air engine comprising:
a cylinder having an interior with hot and cold ends;
a displacer piston within the hot end of the cylinder;
a window in the hot end of the cylinder;
a solar collector directing radiation through the window onto the displacer piston within the cylinder;
a layer of regenerator material containing a carbon foam on the face of the displacer piston; and
a thin layer of absorptive material on the regenerator material containing nickel III oxide (Ni₂O₃).

11. The solar-powered hot air engine of claim 10 further comprising a thin layer of absorptive material with high absorptivity and low emissivity on the interior of the hot end of the cylinder.

12. The solar-powered hot air engine of claim 11 further comprising a layer of regenerator material having low thermal conductivity beneath the layer of absorptive material on the interior of the hot end of the cylinder.
